(19) United States
(12) Patent Application Publication
(10) Pub. No.: US 2014/0315007 A1
(43) Pub. Date: Oct. 23, 2014

(54) WINDOW FOR DISPLAY DEVICE AND DISPLAY DEVICE INCLUDING THE WINDOW

(71) Applicant: SAMSUNG DISPLAY CO., LTD.,, Yongin-si (KR)

(72) Inventors: Ju-Suk OH, Yongin-City (KR); Yuki HONGO, Yongin-City (KR); Hun-Kyo KIM, Yongin-City (KR)

(21) Appl. No.: 14/041,060

(22) Filed: Sep. 30, 2013

(30) Foreign Application Priority Data
Apr. 22, 2013 (KR) 10-2013-0044416

(51) Int. Cl. B32B 27/08; B29C 45/16

(52) U.S. Cl. CPC B32B 27/08; B29C 45/1679
USPC 428/217; 428/412; 428/336; 428/335; 428/334; 428/220; 264/259

(57) ABSTRACT

A window for a display device is disclosed. The window for a display device includes a polymer resin layer including a first polymer resin and a light transmittance film positioned on at least one side of the polymer resin layer, the light transmittance film including a hard coating layer and an auxiliary layer positioned under the hard coating layer, the auxiliary layer including a second polymer resin having surface hardness of at least about 2H and a glass transition temperature (Tg) of at least about 85° C., and a display device including the same.

### CLAIM OF PRIORITY

This application makes reference to, incorporates the same herein, and claims all benefits accruing under 35 U.S.C. §119 from an application for WINDOW FOR DISPLAY DEVICE AND DISPLAY DEVICE INCLUDING THE WINDOW, earlier filed in the Korean Intellectual Property Office on Apr. 22, 2013, and there duly assigned Serial No. 10-2013-0044416.

### BACKGROUND OF THE INVENTION

1. Field of the Invention

A window for a display device and a display device including the same are disclosed.

2. Description of the Related Art

Currently known display devices include a liquid crystal display (LCD), a plasma display panel (PDP), an organic light emitting diode display (OLED), a field effect display (FED), an electrophoretic display device, and the like. Such a display device includes a display module displaying an image and a window protecting the display module. The window may be made of glass. However, since the glass may be easily broken by an external impact, when applied to a portable device such as a mobile phone, the window may be easily damaged. Therefore, a window for this application that is made of a plastic material instead of glass has recently been researched. However, as a display device having a touch screen function is used, a hand or a sharp tool such as a pen may frequently contact one side of the window. With these frequent contacts, the window made of plastic may be easily scratched on the surface. In addition, the window made of plastic may undergo appearance deformation such as curling or waving.

### SUMMARY OF THE INVENTION

One embodiment of the present invention provides a window for a display device that prevents appearance deformation while simultaneously improving impact resistance and surface hardness.

Another embodiment provides a display device including the window for a display device.

According to one embodiment, a window for a display device includes a polymer resin layer including a first polymer resin and a light transmittance film positioned on at least one side of the polymer resin layer, the light transmittance film including a hard coating layer and an auxiliary layer positioned under the hard coating layer, the auxiliary layer including a second polymer resin having surface hardness of at least about 2H and a glass transition temperature (Tg) of at least about 85° C.

The auxiliary layer may have a lower surface hardness than the hard coating layer has.

The auxiliary layer may have surface hardness of from about 2H to about 5H, and the hard coating layer may have surface hardness of from about 5H to about 8H.

The hard coating layer may include one of an organic material, an inorganic material and an organic/inorganic composite compound.

The hard coating layer may include polysilsesquioxane.

The hard coating layer may have a thickness of from about 20 μm to about 100 μm.

The second polymer resin may have a glass transition temperature (Tg) of from about 85° C. to about 160° C.

The second polymer resin may include one of polyester, polycarbonate, polymethylmethacrylate, a polyaryl-based resin, a modified fluoro-based resin and a combination thereof.

The first polymer resin may include one of polycarbonate (PC), polymethylmethacrylate (PMMA), a cycloolefin polymer (COP), a copolymer thereof and a combination thereof.

The light transmittance film may further include a binder layer positioned between the polymer resin layer and the auxiliary layer.

The light transmittance film may further include a plastic substrate.

The plastic substrate may include one of a polyethyleneterephthalate (PET) film, a polycarbonate (PC) film, a polymethylmethacrylate (PMMA) film, a polycarbonate/polymethylmethacrylate (PC/PMMA) film and a combination thereof.

The light transmittance film may further include a binder layer positioned between the plastic substrate and the polymer resin layer.

The plastic substrate may have a thickness of from about 50 μm to about 100 μm, and the binder layer may have a thickness of from about 5 μm to about 10 μm.

The light transmittance film may include an IMD (in mold decoration) film.

The window for a display device may have impact resistance as indicated by a drop height of at least about 40 cm as determined by a ball drop measurement device using a 130 g ball.

The window for a display device may have surface hardness of at least about 7H.

The window for a display device may have a maximum thickness of about 1 mm.

The window for a display device may be obtained by injection-molding the light transmittance film and the polymer resin in a film insert injection molding process.

According to another embodiment, a display device including the window for a display device is provided.

The window for a display device prevents appearance deformation while improving impact resistance and surface hardness simultaneously.

### BRIEF DESCRIPTION OF THE DRAWING

FIG. 1 is a cross-sectional view having a window for a display device according to one embodiment.

### DEFINITIONS

Ball drop measurement device: device that measures impact resistance in a target sample by means of dropping a 130 g steel ball onto the center of the sample from increasing heights, generally through a vertical tube. The largest drop height that does not leave a crack in the sample is a measure of the impact resistance of the sample.

Film insert injection molding: injection molding process for forming plastic pieces involving insertion of decorated, shaped and trimmed film products into the mold.

In mold decoration film: decorated film used in the film insert injection molding process.

Light transmittance film: substantially transparent film that overlays the surface of a display device and may comprise a plurality of distinct layers.

Pencil hardness tester: a semi-automated device for testing scratch hardness in a plastic sample, the test involving contact of the sample with a pressure head, the pressure head to be applied at a series of reproducible force levels.

Substrate: base layer upon which the remainder of the display device is built.

Surface hardness: a measure of the resistance of a sample to fracture or permanent plastic deformation.

Surface hardness scale: manner of characterizing surface hardness by means of standard pencil grades, which are, from hardest to softest, 9H, 8H, 7H, 6H, 5H, 4H, 3H, 2H, H, F, HB, B, 2B, 3B, 4B, 5B, 6B, 7B, 8B, 9B.

### DETAILED DESCRIPTION OF THE INVENTION

Certain exemplary embodiments of the invention will be described more fully hereinafter with reference to the accompanying drawings. As those skilled in the art would realize, the described embodiments may be modified in various different ways without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it may be directly on the other element or intervening elements may also be present. In contrast, when an element is referred to as being “directly on” another element, there are no intervening elements present.

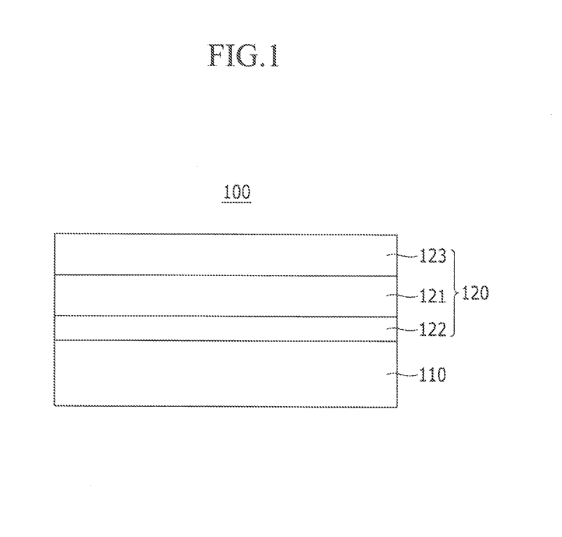

Referring to FIG. 1, a window for a display device according to one embodiment will be described.

FIG. 1 is a cross-sectional view showing a window for a display device according to one embodiment.

A window 100 for a display device according to one embodiment may include a light transmittance film 120 positioned on one side of a polymer resin layer 110.

The polymer resin layer 110 may be made of an injection moldable first polymer resin. The injection moldable first polymer resin may include, for example, one of polycarbonate (PC), polymethylmethacrylate (PMMA), a cycloolefin polymer (COP), a copolymer thereof and a combination thereof. Herein, the ‘combination’ may refer to one of a blend and a stack of at least two layers.

The polymer resin layer 110 may have a thickness, for example, of from about 600 to about 900 μm, and, in certain embodiments, from about 670 to about 820 μm.

When the polymer resin layer 110 has a thickness within the prescribed range, the hardness of the resulting resin layer may be secured and, thus, conditions required for injection may be determined, and high temperature and humidity deformation of the hard coating layer may be reduced in comparison with polymer resin layers having thicknesses outside of the prescribed range. Also, sufficient space for the first polymer resin to flow into during the injection-molding step in a film insert injection molding process may be allowed for, and thus impact resistance and surface hardness characteristics of the first polymer resin may be secured and good appearance may be obtained.

The light transmittance film 120 may include a hard coating layer 123, an auxiliary layer 121, and a binder layer 122.

The hard coating layer 123 may be positioned on the uppermost layer of a window 100 for a display device and may secure surface hardness of the window. Herein, the hard coating layer 123 is positioned on the uppermost layer of a window 100 for a display device and thus, directly has an influence on surface hardness of the window, which does not exclude possibility of forming an additional layer applying an additional function, for example, an antireflective film, thereon.

The hard coating layer 123 may include, for example, one of an organic material, an inorganic material and an organic/inorganic composite compound. Herein the organic material may include, for example, one of an acryl-based compound, an epoxy-based compound and a combination thereof, the inorganic material may include, for example, one of silica, alumina and a combination thereof, and the organic/inorganic composite compound may include, for example, polysilsesquioxane. Specifically, the hard coating layer 123 may include polysilsesquioxane.

The hard coating layer 123 may be a monolayer or a plural layer, and may have a thickness, for example, of from about 20 μm to about 100 μm. When the hard coating layer 123 has a thickness of more than about 100 μm, impact resistance may be remarkably decreased.

The hard coating layer 123 may have a surface hardness of from about 5H to about 8H, and, more specifically, may have a surface hardness of from about 7H to about 8H. The surface hardness may be measured by applying a load of 1 kg with a pencil hardness tester (BMS Tech). With the surface hardness within the range, surface scratching may be prevented.

The auxiliary layer 121 may be positioned under the hard coating layer 123, and thus may complement the hard coating layer 123, further contributing to its ruggedness under conditions of high temperature and humidity and improving the impact resistance of the window 100 for a display device.

The auxiliary layer 121 may be in a form of a film used in a film insert forming process or may be in the form of a coating layer.

The auxiliary layer 121 may have a surface hardness of from about 2H to about 5H, which may be lower than the surface hardness of the hard coating layer 123. Accordingly, the auxiliary layer 121 may improve the reliability and impact resistance of the window for a display device while not affecting surface hardness of the hard coating layer 123. When the auxiliary layer has a surface hardness of less than or equal to H, the hard coating layer 123 should be made thick enough so that sufficient hardness may be secured.

The second polymer resin may support the hard coating layer 123, preventing or diminishing its deformation under high temperature and humidity environments, and the use of a second polymer resin layer may decrease appearance deformation such as curl in the polymer layer composite and thus improve the reliability of the manufacturing process. Herein, reliability decreases may refer to, for example, formation of waves in a polymer layer due to curling at the polymer injection temperature used during the film insert injection molding manufacturing process. The second polymer resin may be, for example, one of polyester, polycarbonate, polymethylmethacrylate, a polyacryl-based resin, a modified fluoro-based resin and a combination thereof.

The binder layer 122 is a layer interposed between the polymer resin layer 110 and the auxiliary layer 121 and serving to bond the two layers together. The binder layer 122 may include, for example, one of a two-component curable resin and an acryl-based binder. The binder layer 122 may have a thickness, for example, of from about 5 μm to about 10 μm.

The light transmittance film may further include a plastic substrate (not shown). The plastic substrate may be a film used for a film insert forming process, and may be, for example, one of a polyethyleneterephthalate (PET) film, a polycarbonate (PC) film, a polymethylmethacrylate (PMMA) film, a polycarbonate/polymethylmethacrylate (PC/PMMA) film and a combination thereof. The plastic substrate may have a thickness, for example, of from about 50 μm to about 100 μm.

When the plastic substrate is further included, the binder layer 122 may be positioned, for example, between the plastic substrate and the polymer resin layer 110.

The light transmittance film 120 may be, for example, an IMD film (in mold decoration film).

The light transmittance film 120 may be formed on one side of the polymer resin layer 110 but is not limited thereto and may be formed on both sides of the polymer resin layer 110.

The window 100 for a display device may be obtained by injection-molding the light transmittance film 120 and the polymer resin according to a film insert injection molding process.

The window 100 for a display device may have a maximum thickness of about 1 mm.

The window 100 for a display device may exhibit advantageous impact resistance and surface hardness characteristics simultaneously, as described above. For example, the window 100 for a display device may have an impact resistance of at least 40 cm as measured by dropping a load of 130 g using a Ball drop measurement device and simultaneously may have a surface hardness of at least about 7H as measured by application of a load of 1 kg with a pencil hardness tester (BMS Tech).

The above described window for a display device may find application in various display devices. The display device may be one of a liquid crystal display (LCD), an organic light emitting diode (OLED) display, a plasma display, an electric field effect display device, an electrophoresis display device, and the like, but is not limited thereto.

The window for a display device may be disposed on a display module, and display modules that may usefully be paired with the inventive window for a display device include a liquid crystal display module, an organic light emitting display module, a plasma display module, an electric field effect display module, an electrophoresis display module, and the like.

Hereinafter, the present disclosure is illustrated in more detail with reference to examples. However, these examples are exemplary, and the present disclosure is not limited thereto.

### Manufacture of Window for Display Device

### EXAMPLE 1

A polymethyl methacrylate solution (Tg=90° C.) (OPSTER KZ6445A, JSR Co.) including a second polymer resin was coated on one side of a PET film (PET100A4300, TOYOBO Co., Ltd.) and cured under a condition of a high-pressure mercury lamp, and a dose of 300 mJ/cm², forming an auxiliary layer having pencil hardness of 3H. Next, a hard coating layer was formed by coating a polysilsesquioxane a solution (BS-907, Arakawa Inc.) onto the cured second polymer resin layer, drying the hard coating layer at 80° C. for 1 minute, and curing it by irradiation with ultraviolet (UV) light (300 mJ/cm²). Then, a two-component curable resin (IMB00002, Teikoku Printing Inks Mfg. Co., Ltd.) was coated on the other side of the PET film and dried at 100° C. for 10 minutes. Subsequently, the dried two-component curable resin was pre-cured at 100° C., forming a binder layer. Then, the PET film was put in an injection molder to injection-mold the polycarbonate-based (PC) resin (HFD-1810, Sabic Co.), manufacturing a 1 mm-thick window for a display device including a polycarbonate-based (PC) resin layer. Each layer has a thickness as follows.

Hard coating layer: 0.025 μm

Auxiliary layer: 0.2 μm

Two-component curable resin (binder) layer: 0.01 μm

Polycarbonate-based (PC) resin layer: 0.765 μm

### EXAMPLE 2

A polysilsesquioxane solution (BS-907, Arakawa Inc.) was coated on one side of a polyester-based film (Tg=153° C., pencil hardness=3H), which had been previously coated with a second polymer resin (DX-01, Nichigo Orga). The polysilsesquioxane solution was then dried at 80° C. for 1 minute and cured by irradiation with ultraviolet (UV) light (300 mJ/cm²). Subsequently, a two-component curable resin (IMB00002, Teikoku Printing Inks Mfg. Co., Ltd.) was coated on the other side of the polyester-based film and dried at 100° C. for 10 minutes. Then, the coated polyester-based film was pre-cured at 100° C. Then, the polyester-based film was put in an injection molder to injection-mold a polycarbonate-based (PC) material (HFD-1810, Sabic Co.), manufacturing a 1 mm-thick window for a display device including a polycarbonate-based (PC) resin layer. Each layer has a thickness as follows.

Hard coating layer: 0.025 μm

Auxiliary layer: 0.2 μm

Two-component curable resin (binder) layer: 0.01 μm

Polycarbonate-based (PC) resin layer: 0.765 μm

### EXAMPLE 3

A 1 mm-thick window for a display device including a polycarbonate-based (PC) resin layer was manufactured according to the same method as was used in Example 2 except for using a polyester-based film (Tg=155° C., pencil hardness 5H) (TA-01, Nichigo Orga) instead of the polyester-based film (Tg=153° C., pencil hardness of 3H) (DX-01, Nichigo Orga). Each layer has a thickness as follows.

Hard coating layer: 0.025 μm

Auxiliary layer: 0.2 μm

Two-component curable resin (binder) layer: 0.01 μm

Polycarbonate-based (PC) resin layer: 0.765 μm

### COMPARATIVE EXAMPLE 1

A 1 mm-thick window for a display device including a polycarbonate-based (PC) resin layer was manufactured according to the method of Example 1 except that no polymethyl methacrylate solution (OPSTER KZ6445A, JSR Co.) was used. Each layer has a thickness as follows.

Hard coating layer: 0.125 μm

PET film: 0.1 μm

Two-component curable resin (binder) layer: 0.01 μm

Polycarbonate-based (PC) resin layer: 0.765 μm

### COMPARATIVE EXAMPLE 2

A 1 mm-thick window for a display device including a polycarbonate (PC) resin layer was manufactured according to the method of Example 1 except that a polystyrene a solution (Tg=47° C., pencil hardness H) (ef-36, Soken Co., Ltd.) was used instead of the polymethyl methacrylate solution (OPSTER KZ6445A, JSR Co.). Each layer had a thickness as follows.

Hard coating layer: 0.025 μm

Auxiliary layer: 0.2 μm

Two-component curable resin (binder) layer: 0.01 μm

Polycarbonate (PC) resin layer: 0.765 μm

### COMPARATIVE EXAMPLE 3

A 1 mm-thick window for a display device including a polycarbonate (PC) resin layer was manufactured according to the method of Example 1 except that a modified polymethylmethacrylate solution (Tg=94° C., pencil hardness=6B) (VRL40, Mitsubishi rayon Co., Ltd.) was used instead of the polymethylmethacrylate solution (OPSTER KZ6445A, JSR Co.). Each layer had a thickness as follows.

Hard coating layer: 0.025 μm

Auxiliary layer: 0.2 μm

Two-component curable resin (binder) layer: 0.01 μm

Polycarbonate (PC) resin layer: 0.765 μm

### Evaluation

Impact resistance, surface hardness and appearance of the windows for a display device according to Examples 1 to 4 and Comparative Examples 1 to 3 were evaluated.

The impact resistance was evaluated by measuring a maximum height for which the window for a display device had no crack when a metal weight having a load of 130 g was dropped to impact the center of the window for a display device using a Ball Drop measuring device.

The surface hardness was measured by applying a load of 1 kg with a pencil hardness tester (BMS Tech).

The appearance was evaluated by examining whether a window for a display device curled or not upon aging for 120 hours at 85° C. at a humidity of 85%, taking note of the highest height of the curled window for a display device from a flat surface supporting it.

The results are provided in Table 1.

TABLE 1

| | | Properties of hard | | Properties of | | | | |
|---|---|---|---|---|---|---|---|---|
| | | coating layer | | auxiliary layer | | | | |
| | | | pencil | Glass | | | | |
| | Total | | hardness | transition | | Results | | |
| | Thickness | Thickness | (On Glass | temperature | Pencil | Impact | Surface | |
| | (mm) | (μm) | 700 um) | (Tg) | hardness | resistance | hardness | Appearance |
| Ex. 1 | 1.0 | 25 | 8H | 90 | 3H | 55 cm crack | 7H | 0.5 mm |
| Ex. 2 | 1.0 | 25 | 8H | 153° C. | 3H | 55 cm crack | 7H | 0.7 mm |
| Ex. 3 | 1.0 | 25 | 8H | 155° C. | 5H | 45 cm crack | 8H | 1 mm |
| Comp. | 1.0 | 125 | 8H | — | — | 5 cm crack | 7H | 6 mm |
| Ex. 1 | | | | | | | | |
| Comp. | 1.0 | 25 | 8H | 47° C. | H | 40 cm crack | 5H | 4 mm |
| Ex. 2 | | | | | | | | |
| Comp. | 1.0 | 25 | 8H | 94° C. | 6B | 50 cm crack | 2H | 1 mm |
| Ex. 3 | | | | | | | | |

Referring to Table 1, the windows for a display device according to Examples 1 to 3 showed high impact resistance and surface hardness and satisfactory appearance. On the contrary, the window for a display device using no auxiliary layer according to Comparative Example 1 showed very low impact resistance and unsatisfactory appearance, the window for a display device using an auxiliary layer having a glass transition temperature of less than 85° C. according to Comparative Example 2 showed low impact resistance and unsatisfactory appearance, and the window for a display device using an auxiliary layer having low surface hardness according to Comparative Example 3 showed unsatisfactory surface hardness appearance. Based on the result, the window for a display device including an auxiliary layer having surface hardness of at least 2H and a glass transition temperature (Tg) of at least 85° C. had satisfactory impact resistance, hardness and appearance.

While this disclosure has been described in connection with what are presently considered to be practical exemplary embodiments, it is to be understood that the invention is not limited to the disclosed embodiments, but, on the contrary, the present disclosure is intended to cover various modifications and equivalent arrangements included within the spirit and scope of the appended claims.

### DESCRIPTION OF SYMBOLS

100: window for a display device
110: polymer resin layer
120: light transmittance film
121: auxiliary layer
122: binder layer
123: hard coating layer

What is claimed is:

1. A window for a display device, comprising:
a polymer resin layer including a first polymer resin; and
a light transmittance film positioned on at least one side of the polymer resin layer, the light transmittance film comprising:
a hard coating layer; and
an auxiliary layer positioned under the hard coating layer,
the auxiliary layer comprising a second polymer resin
having surface hardness of greater than or equal to about 2H and a
glass transition temperature (Tg) of at least about 85° C.

2. The window for a display device of claim 1, the auxiliary layer having a lower surface hardness than the hard coating layer has.

3. The window for a display device of claim 2, the auxiliary layer having a surface hardness of from about 2H to about 5H, and the hard coating layer having a surface hardness of from about 5H to about 8H.

4. The window for a display device of claim 1, the hard coating layer comprising one of an organic material, an inorganic material and an organic/inorganic composite compound.

5. The window for a display device of claim 1, the hard coating layer comprising polysilsesquioxane.

6. The window for a display device of claim 1, the hard coating layer having a thickness of from about 20 μm to about 100 μm.

7. The window for a display device of claim 1, the second polymer resin having a glass transition temperature (Tg) of from about 85° C. to about 160° C.

8. The window for a display device of claim 1, the second polymer resin comprising one of polyester, polycarbonate, polymethylmethacrylate, a polyacryl-based resin, a modified fluoro-based resin and a combination thereof.

9. The window for a display device of claim 1, the first polymer resin comprising one of polycarbonate (PC), polymethylmethacrylate (PMMA), a cycloolefin polymer (COP), a copolymer thereof and a combination thereof.

10. The window for a display device of claim 1, the light transmittance film further comprising a binder layer positioned between the polymer resin layer and the auxiliary layer.

11. The window for a display device of claim 1, the light transmittance film further comprising a plastic substrate.

12. The window for a display device of claim 11, the plastic substrate comprising one of a polyethyleneterephthalate (PET) film, a polycarbonate (PC) film, a polymethylmethacrylate (PMMA) film, a polycarbonate/polymethylmethacrylate (PC/PMMA) film and a combination thereof.

13. The window for a display device of claim 12, the light transmittance film further comprising a binder layer positioned between the plastic substrate and the polymer resin layer.

14. The window for a display device of claim 13, the plastic substrate having a thickness of from about 50 μm to about 100 μm and the binder layer having a thickness of from about 5 μm to about 10 μm.

15. The window for a display device of claim 1, the light transmittance film comprising an IMD (in mold decoration) film.

16. The window for a display device of claim 1, the window for a display device having impact resistance as indicated by a drop height of at least about 40 cm as determined by a ball drop measurement device using a 130 g ball.

17. The window for a display device of claim 1, the window for a display device having a surface hardness of at least about 7H.

18. The window for a display device of claim 1, the window for a display device having a maximum thickness about 1 mm.

19. The window for a display device of claim 1, the window for a display device being obtained by injection-molding the light transmittance film and the polymer resin in a film insert injection molding manufacturing process.

20. A display device comprising the window for a display device according to claim 1.
